(19) United States
(12) Patent Application Publication
(10) Pub. No.: US 2026/0254808 A1
(43) Pub. Date: Aug. 27, 2026

(54) METHOD AND SYSTEM FOR AUTHENTICATING A USER TO ACCESS A WORKSTATION

(71) Applicant: KEYNECTIS, PUTEAUX (FR)

(72) Inventors: Christophe GUIONNEAU, Grenoble (FR); Olivier BORG, Neauphle-le-Château (FR); Denis GALIANA, La Garenne-Colombes (FR)

(73) Assignee: KEYNECTIS, PUTEAUX (FR)

(21) Appl. No.: 19/547,577

(22) Filed: Feb. 23, 2026

(30) Foreign Application Priority Data
Feb. 26, 2025 (EP) 25305253.4

(51) Int. Cl. H04L 9/40

(52) U.S. Cl. CPC H04L 63/083

(57) ABSTRACT

The invention relates to a method (100) for authenticating a user on a workstation, with a view to unlocking said workstation, said method (100) comprising an authentication phase (110) comprising the following steps:
displaying (112), by said workstation, a web page from an identity server, called IdP server;
providing, by said user to said IdP server, and through said web page, a username and a user password;
authenticating (118) said user based on said username and said user password;
in case of successful authentication, transmitting, by said IdP server to said workstation, a password for unlocking said workstation; and
unlocking the workstation.
   It likewise relates to an authentication system implementing such a method.

This application claims priority to European Patent Application Number 25305253.4, filed 26 Feb. 2025, the specification of which is hereby incorporated herein by reference.

### BACKGROUND OF THE INVENTION

### Field of the Invention

At least one embodiment of the invention relates to a method for authenticating a user to access a workstation, that is to say for unlocking a workstation and opening a session on the operating system of said workstation. At least one embodiment of the invention also relates to a computer program and a system implementing such a method.

The field of at least one embodiment of the invention is the field of authenticating a user in order to access a workstation, that is to say to unlock a workstation and open a session on the operating system of said workstation.

### Description of the Related Art

User access to a workstation belonging to a local computer network, such as a corporate network, generally requires user authentication. When the workstation is located on the local network, authentication is carried out using a database that stores access rights for each workstation and each user, such as the Windows Active Directory (AD). In this case, the domain controller can be used to dynamically manage the access rights of each user for each workstation.

When the workstation is located outside the local network, access to the workstation is managed via a local authentication cache, stored locally in the workstation, and indicating access rights to the workstation. In this case, it is not possible to dynamically manage access rights for workstations belonging to a local network and located outside the local network. Indeed, in this case, it is not possible to modify or update workstation access rights with the local network domain controller.

Patent U.S. Pat. No. 11,985,242B1 is known, which describes a solution for authenticating a user before he unlocks a workstation. The solution described in this document allows flexible authentication of the user's identity, but does not allow modification or updating, or in general, dynamic and flexible management of access to a workstation when it is outside the local network. For example, it does not allow the password used to access the workstation to be managed, or known, let alone checked.

One aim of one or more embodiments of the invention is to solve at least one of the above-mentioned shortcomings.

Another aim of one or more embodiments of the invention is to provide a solution for authenticating a user to access a workstation belonging to a local network, allowing dynamic management of access rights to said workstation, even when said workstation is outside the local network.

Another aim of one or more embodiments of the invention is to provide a solution for authenticating a user to access a workstation belonging to a local network, allowing broader and more comprehensive management of access rights to said workstation, even when said workstation is outside the local network.

### BRIEF SUMMARY OF THE INVENTION

The one or more embodiments of the invention makes it possible to achieve at least one of the aforementioned goals by means of a method for authenticating a user on a workstation belonging to a local network, such as a company network, with a view to unlocking said workstation and opening a session on an operating system of said workstation, said method comprising an authentication phase comprising the following steps:
displaying, by said workstation, a web page from an identity server, called IdP server;
providing, by said user to said IdP server, and through said web page, a username for said user and a user password;
authenticating said user based on said username and said user password;
in case of successful authentication, transmitting, by said IdP server to said workstation, a password for unlocking said workstation; and
   unlocking said workstation with said unlock password.

At least one embodiment of the invention proposes the use of an identity server, called IdP server, to verify a user's identity based on a username and password supplied by the user. This authenticates the user before he unlocks the workstation and opens a session on the operating system of the workstation.

Above all, and in a manner different from the solution described in patent U.S. Pat. No. 11,985,242B1, at least one embodiment of the invention makes it possible to communicate to the workstation, the unlock password to be used to unlock said workstation and open a session on the operating system of said workstation. At least one embodiment of the invention thus goes beyond the solution described in patent U.S. Pat. No. 11,985,242B1.

In this way, at least one embodiment of the invention allows greater control over access rights to workstations when they are located outside the local network. At least one embodiment of the invention makes it possible to control access rights and unlock passwords for workstations, even when they are outside the local network. For example, one or more embodiments of the invention allows workstation unlock passwords to be changed, and access rights to workstations to be modified dynamically and flexibly, when said workstations are outside the local network.

“Local network” refers to a computer network in which access to resources is managed by a domain controller. Each computer resource, such as each workstation, is part of a closed computer domain, to which it is added, when it is added to said computer domain.

In at least one embodiment of the invention, a password can be of any type. It can be a string of alphabetic, numeric or alphanumeric characters. Alternatively, the password can be biometric data such as a fingerprint or an easy print. In one or more embodiments, the password can be a token or a certificate, for example stored on a physical medium such as a USB key, smart card, etc. At least one embodiment of the invention is not limited to one type, or format, of password.

It should be noted that the IdP server is not the local network authentication server, or an IDAAS server used by the local network, or a local network identity repository. The IdP server can be located on the local network. Alternatively, the IdP server can be located outside the local network. In all cases, it can be accessed via an Internet connection.

According to one or more embodiments, the user password supplied by the user can be the unlock password.

In this case, the user provides the unlock password that unlocks the workstation. This password is transmitted to the IdP server for verification, and then retransmitted by the IdP server to the workstation upon successful verification.

In other words, even if the user has the unlock password, it is communicated to the workstation by the IdP server and not by the user himself.

According to one or more embodiments, the user password supplied by the user may be different from the unlock password.

In this case, the user password is used to authenticate the user. In the case of successful user authentication, the unlock password, which is different from the user password, is obtained and transmitted by the IdP server to the workstation.

In at least one embodiment, the unlock password may or may not be known to the user. In other words, in this case, it is possible to implement a workstation unlock mechanism in which the unlock password used to unlock the workstation is not known to the user. This makes it possible to manage workstation access more securely and safely. This also allows more flexible and dynamic management of access to the workstation.

In at least one embodiment, the unlock password can be fixed and unchangeable, at least for multiple workstation unlocking occurrences.

Alternatively, in at least one embodiment, it is possible to change the unlock password for at least one, and in particular each, instance of workstation unlocking. For example, a one-time unlock password can be generated each time the user wishes to unlock the workstation.

The user password supplied by the user can be a password that identifies him to the IdP server. In this case, the user password can be associated with said user, and in particular with a user account/profile of said user with respect to the IdP server, previously created at the IdP server. It should be noted that this user profile/account of said user at the IdP server may be independent of any other account of said user in the local network, or at the workstation.

Alternatively, in one or more embodiments, the user password supplied by the user can be a password associated with the user in the local network, for example a password of an account/profile of said user in the local network. In this case, the IdP server may need to contact an identity reference of said local network, such as for example a domain controller or an authentication server of said local network, for user authentication.

According to at least one embodiment, the user password provided by the user can be a password from any other identity or authentication server, such as an IDAAS (Identity As A Service) server, a third-party authentication server or a social authentication server. In this case, the IdP server may need to contact the third-party server to perform user authentication.

In this case, the user can be redirected to said third-party server. He is authenticated with a password or other means, and the third-party server sends a proof of authentication back to the IdP server. Redirection can be visible to the user: web redirection (and proof of Oauth (OIDC) or SAML authentication). In this case, the password may not pass through the IDP, but only through the third-party server. Alternatively, redirection can be invisible to the user, for example using the RADIUS protocol. In this case, the IDP server transmits the password to the external RADIUS server, which answers ‘yes’ or ‘no’to the IdP server depending on the authentication result.

According to one or more embodiments, the unlock password can be known and stored by the IdP server.

In this case, if authentication is successful, the IdP server can transmit the unlock password to the workstation.

The unlock password may be known to the IdP server because it can be supplied by the user, for example during the supply step of the authentication phase. Alternatively, in at least one embodiment, the unlock password can be supplied by the user before the authentication phase, for example during a step of registering said user with said IdP server. Alternatively, in at least one embodiment, the unlock password can be provided by the user during a previous iteration of the authentication phase.

The unlock password may be known to the IdP server, as it can be supplied by a local network administrator before the authentication phase.

The unlock password may be known to the IdP server, as it can be obtained by said IdP server, for example from a local network authentication server, or from any other identity repository of said local network, before the authentication phase.

According to one or more embodiments, the authentication phase may comprise a step in which the IdP server obtains the unlock password from a third-party entity.

In this case, the unlock password is not known to the IdP server and must be obtained during the authentication phase.

The third-party entity can be any type of entity.

For example, the third-party entity could be a local network authentication server. In this case, communication between the IdP server and the local network authentication server can be encrypted.

For example, the third-party entity could be a local network administrator.

According to at least one embodiment, the unlock password can be requested from the user himself.

In this case, the IdP server requests said password from said user during the authentication phase, for example via the web page of said IdP server.

In any case, the authentication phase can comprise encrypting the unlock password before transmitting it to the workstation.

The password encryption can be performed using any known technique. For example, the unlock password can be encrypted with a public key associated with the workstation, and in particular with its authentication process, previously communicated to the IdP server.

According to one or more embodiments, the unlock password can be changeable. In this case, the method according to one or more embodiments of the invention, and in particular the authentication phase, can comprise a step for updating, or changing, the unlock password.

This unlock password update step can be carried out after the authentication phase, preferably in the event of successful authentication. This update step can be carried out after the IdP server has transmitted the unlock password to the workstation, in the event of successful authentication.

The update step can be performed each time the workstation is unlocked, or at a predetermined frequency.

If the unlock password is changed, the new unlock password can be stored on the IdP server in association with the user and/or workstation.

In addition, the new unlock password can be transmitted to the local network authentication server in order to update said unlock password at said authentication server.

The unlock password can be changed randomly, so that the new password is generated at random. Alternatively, in at least one embodiment, the new unlock password can be obtained according to a predetermined relationship, and/or based on a predetermined data.

The unlock password can be changed at the workstation. In this case, the new password is transmitted to the IdP server for storage, for example in encrypted form.

The unlock password can be changed on the IdP server. In this case, the new password is transmitted to the workstation for storage, e.g. in encrypted form.

According to one or more embodiments, when the user is known to the IdP server, the authentication step can be carried out by said IdP server.

The user may be known to the IdP server because he has already used the IdP server during a previous execution of the authentication phase, during which, or following which, a user account was created for said user and stored at said IdP server.

The user may be known to the IdP server because he has registered with the IdP server during a registration step.

The user may be known to the IdP server because he has been registered, by a third-party entity, with said IdP server during a registration step. User registration can be carried out by a local network administrator, for example manually. User registration can be carried out by a local authentication server, or by a local network identity repository, such as a local network AD. Registration can be carried out by synchronizing said IdP server with the authentication server, respectively with said identity repository.

According to one or more embodiments, optionally, the method according to at least one embodiment of the invention may comprise such a registration step before the authentication phase

According to one or more embodiments, the user is not known to the IdP server. In this case, the authentication step can be carried out by a third-party authentication entity, in particular the local network authentication server.

In this case, the IdP server communicates the username and password supplied by the user to said entity for authentication. If authentication is validated by the third-party entity, then said third-party entity communicates proof of successful authentication to said IdP server.

In this case, the IdP server can communicate with the third-party entity using any suitable communication technique.

Advantageously, the IdP server can communicate with the third-party entity, such as the local network authentication server, using secure communication. Such secure communication can be achieved via a VPN, for example at the initiative of the IdP server to the local network. Alternatively, in at least one embodiment, such secure communication can be achieved using a communication gateway, in the local network, establishing a secure bidirectional communication for exchanging data between the IdP server and the authentication server in the local network.

Of course, these examples are by no means exhaustive, and other communication techniques may also be used.

In this case, following successful authentication, the method according to one or more embodiments of the invention can optionally comprise, during or after the authentication phase, a step of creating a user account, for said user, at said IdP server.

The user account can be created with the username and password supplied by the user.

Alternatively, in at least one embodiment, the user account can be created with a username and/or password other than those supplied by the user. In this case, said other username and/or said other password are provided to the user for later use, for example during a subsequent iteration of the authentication phase.

According to one or more embodiments, the authentication step can perform authentication using a strong authentication method.

Of course, the authentication step can perform authentication using any other authentication technique.

According to one or more embodiments, the method according to at least one embodiment of the invention may comprise a step of setting up an authentication by a strong authentication method, following the authentication step.

According to one or more embodiments, the user may already be known to the workstation. In this case, the user account associated with the user is used to open the user's session on said workstation.

According to one or more embodiments, the user may not be known to the workstation. This can happen, for example, when the user has never used the workstation before.

In this case, the authentication phase can comprise a step for creating a user account on the workstation, following the authentication step and before the step of unlocking the workstation. A user account can be created on the workstation in the conventional, standard way, according to the elements communicated by the IdP server.

Optionally, the method according to at least one embodiment of the invention can further comprise a step of transmitting, by the IdP server to the workstation, a proof of authentication specific to the IdP server, which can be used to access at least one SaaS application.

In this case, the IdP server is pre-provisioned to the SaaS application and the proof of authentication provided by the IdP server can be used to authenticate the user to said SaaS application.

The proof of authentication can be of any type, such as an authentication token, an authentication certificate, etc.

According to one or more embodiments, the authentication phase may comprise, before the step of transmitting the unlock password to the workstation, a step of verifying an access condition associated with said user or said workstation, such as a condition relating to the access location or access time.

For example, such an access condition can be relative to the user's profile, when the local network grants different access rights for different profiles.

Alternatively or additionally, in at least one embodiment, such an access condition can be relative to a user's geographical location, where the local network grants different access rights for different geographical locations.

Alternatively or additionally, in at least one embodiment, such an access condition can be relative to an access time, when the local network grants different access rights for different times.

Of course, it is possible to define one or more conditions other than those defined above, which are given by way of non-limiting examples.

According to at least one embodiment of the invention, a non-transitory computer program is proposed comprising computer instructions, which when they are executed, implement the steps of the method according to one or more embodiments of the invention.

The computer program can be in machine language, in C, C++, JAVA, Python, and more generally any type of computer language.

The computer program can be a single computer program, or a set of several computer programs.

In particular, the computer program can comprise:
an authentication client associated with, and in particular installed on, the workstation, and
   an identity server, called IdP server, in communication with said authentication client.

According to at least one embodiment of the invention, there is proposed a system for authenticating a user on a workstation, in order to unlock said workstation and open a session on an operating system of said workstation, said system comprising:
an authentication client installed on said workstation, which can be run before unlocking said workstation; and
an identity server (IdP server);
   configured to implement the method according to at least one embodiment of the invention.

The system according to one or more embodiments of the invention may comprise, in terms of technical means and/or configuration(s) and/or computer program(s), any combination of the features described above with reference to the method according to at least one embodiment of the invention and which are not mentioned herein for brevity.

According to one or more embodiments, the system according to at least one embodiment of the invention can comprise a third-party authentication entity to authenticate the user and/or provide the password for unlocking the workstation.

According to one or more embodiments, the system according to at least one embodiment of the invention can comprise a module for generating an unlock password, located at the workstation or at the IdP server.

### BRIEF DESCRIPTION OF THE DRAWINGS

Other benefits and features shall become evident upon examining the detailed description of an entirely non-limiting embodiment, and from the enclosed drawings in which:

FIG. 1 is a schematic depiction of a non-limiting example of an authentication method according to one or more embodiments of the invention; and

FIG. 2 is a schematic depiction of a non-limiting example of an authentication method according to one or more embodiments of the invention; and

FIG. 3 is a schematic depiction of a non-limiting example of an authentication system according to one or more embodiments of the invention.

### DETAILED DESCRIPTION OF THE INVENTION

It is clearly understood that the one or more embodiments that will be described hereafter are by no means limiting. In particular, it is possible to imagine variants of the one or more embodiments of the invention that comprise only a selection of the features disclosed hereinafter in isolation from the other features disclosed, if this selection of features is sufficient to confer a technical benefit or to differentiate the one or more embodiments of the invention with respect to the prior state of the art. This selection comprises at least one preferably functional feature which lacks structural details, or only has a portion of the structural details if that portion only is sufficient to confer a technical benefit or to differentiate the one or more embodiments of the invention with respect to the prior state of the art.

In the figures, the same reference has been used for the features that are common to several figures.

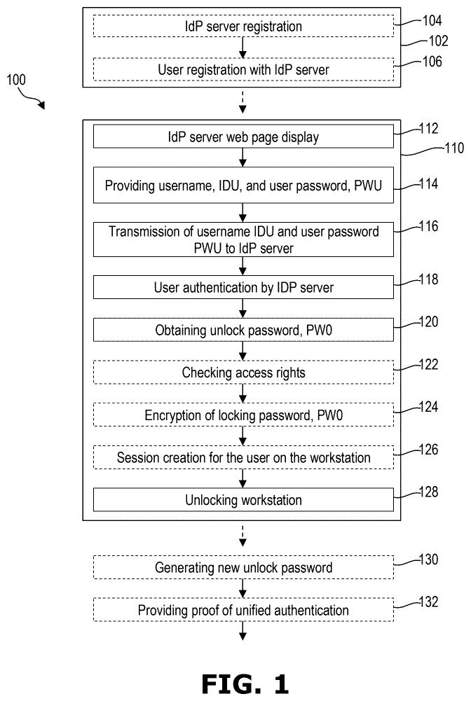

FIG. 1 is a schematic depiction of a non-limiting example of an authentication method according to one or more embodiments of the invention.

The method 100, shown in FIG. 1, can be implemented to authenticate a user in order to access a workstation, that is to say in order to unlock said workstation and launch a session on the operating system of said workstation. In particular, the method 100 can be used to authenticate a user of a computer network, known as a local network, for a workstation belonging to said local network, when said workstation is located outside said local network.

The workstation can be of any type, such as a fixed computer, a laptop, a smartphone, a tablet, a server, and so on.

The method 100 uses an identity server, referred to as an IdP server. It should be noted that the IdP server is not the local network authentication server, or an IDAAS server used by the local network, or a local network identity repository. The IdP server can be located on the local network. Alternatively, the IdP server can be located outside the local network. In all cases, it is accessible from the workstation via an Internet connection.

The method 100 can optionally comprise a registration phase 102.

The registration phase 102 of the method 100 may comprise an optional step 104 of registering the IdP server with a local network authentication server, a local network IDAAS server, or a local network identity repository. During this registration step 104, the IdP server obtains a proof of authentication allowing it to connect to said authentication server or said identity repository, respectively.

The proof of authentication obtained in step 104 is stored at the IdP server for later reuse. The proof of authentication obtained in step 104 can be an authentication token, an authentication server, etc.

This step 104 is optional and not necessary for the implementation of the method 100.

The registration phase 102 of the method 100 can comprise an optional step 106 of registering the user with the IdP server. During this optional registration step 106, a user account is created for the user and stored on the IdP server.

During this step 106, users are assigned a username and password. The username can be identical to the one used to unlock the workstation. Alternatively, the password can be different from the one used to unlock the workstation.

This step 106 is optional and not necessary for the implementation of the method 100.

The method 100 next comprises an authentication phase 110.

This authentication phase 110 can be carried out immediately after the optional registration phase 102. Alternatively, the authentication phase 110 can be carried out well after the optional registration phase 102.

In the example shown in FIG. 1, the user is assumed to be known to the IdP server. In other words, it is assumed that a user account exists for this user on the IdP server. Such a user account may have been created in optional step 106. Alternatively, such a user account may have been created during a previous occurrence of an authentication phase.

The authentication phase 110 comprises a step 112 in which an authentication client installed on the workstation is run to display a web page from the IdP server.

To achieve this, the workstation can be configured to launch the authentication client automatically when it is switched on. Alternatively, the workstation can be configured to offer the user the option of launching, or selecting, said authentication client manually.

It should be noted that, at this stage, the user has not yet unlocked the workstation and no assignment is open for this user on the operating system of the workstation. The user is presented with a workstation authentication page to unlock said workstation.

In step 114, the user provides his username, IDU, and password, PWU, on the IdP server web page displayed by the workstation.

The username IDU and user password PWU supplied in step 114 are those associated with the user's account stored on the IdP server.

The username IDU and user password PWU supplied in step 114 are transmitted to the IdP server in step 116.

In the example shown in FIG. 1, the user is known to the IdP server and has a user account with the IdP server.

In step 118, the IdP server authenticates the user using the username IDU and user password PWU it received in step 116. The IdP server can use any authentication technique. For example, the IdP server can use a strong authentication method, such as two-factor authentication.

If authentication fails, the method is terminated at step 118. Optionally, the negative authentication result can be communicated to the workstation. Optionally, an error message can be displayed at the workstation, for example by the authentication client launched in step 112.

If the user is successfully authenticated in step 118, the IdP server obtains, in step 120, an unlock password, PW0, associated with this user and the workstation, which can be used to unlock said workstation and open a session for said user on the operating system of said workstation.

According to at least one embodiment, the unlock password PW0 can be the user password PWU supplied by the user. In this case, the IdP server can optionally store said user password PWU as the unlock password PW0 in the user's account, if this is not already the case.

According to at least one embodiment, the unlock password PW0 can be:
different from the user password PWU supplied by the user; and
   already known to the IdP server, for example stored with a user account for said user.
      For example, the unlock password PW0 may have been supplied during the optional registration step 106. In another example, the unlock password PW0 may have been obtained during a previous iteration of the authentication phase 110.

According to at least one embodiment, the unlock password PW0 can be:
different from the user password PWU supplied by the user; and
not known to the IdP server.
   In this case, the IDP server can ask the user for the unlock password PW0 in step 120, for example via the web page. The unlock password PW0 can then be supplied by the user. Optionally, the unlock password PW0 thus obtained can be stored in the user's account.

According to at least one embodiment, the unlock password PW0 can be:
different from the user password PWU supplied by the user; and
not known to the IdP server.
   In this case, the IDP server can request said unlock password PW0 from an external entity in step 120. This external entity may, for example, be an administrator of the local network to which the workstation belongs. This external entity may, for example, be a local network authentication server, an IDAAS server used by said local network, or an identity repository of said local network, such as an AD of said local network. This external entity may, in general, be any entity that can authenticate the user and provide the workstation unlock password PW0, and with which the IdP server is registered, for example during the optional registration step 104. The unlock password PW0 may then be supplied by said external entity. Optionally, the unlock password PW0 thus obtained can be stored in the user's account on the IdP server.

By way of one or more embodiments, the IdP server has obtained the unlock password PW0 associated with this user in step 120.

In an optional step 122, the access rights associated with this user can be tested, for example according to the user's geographical location, and/or the current time of day for accessing the workstation, and/or a user profile, and so on.

These access rights can be provided by an authentication server, an IDAAS server, or any other local network identity repository.

These access rights can be specified to the IdP server by a local network administrator, or any other entity.

In step 124, if nothing prevents the user from accessing the workstation, the IdP server transmits the lock password PW0, obtained in step 120, to said workstation.

The lock password PW0 can be encrypted before transmission, using any suitable encryption technique, for example with a public key associated with the workstation, or with the authentication client launched in step 112, and previously communicated to the IdP server. In this case, the encrypted unlock password received by the workstation is decrypted, for example with the private key associated with the public key used for encryption.

In an optional step 126, the workstation can create a session for this user, if no session exists on this workstation for this user. The session is created in the conventional way, for example by an agent installed on the workstation. The unlock password is assigned to this user for the session created.

Of course, if a session exists for this user on the workstation, step 126 is not carried out.

In a step 128, the unlock password PW0 received by the workstation is used to unlock the workstation and open a session on the operating system of said workstation.

Unlocking is done in the conventional way by entering the password on the authentication client of the workstation.

Password entry can be automated and transparent to the user, for example by the authentication client associated with the IdP server and run in step 112, or by the authentication client of the workstation.

The unlock password PW0 can be fixed and non-changeable.

Alternatively, the unlock password PW0 can be changed, for example at the user's request, at the IdP server's request, or at a predetermined frequency. According to at least one embodiment, the unlock password PW0 can be changed each time the workstation is unlocked.

Thus, after the authentication phase 110, the method 100 can comprise an optional step 130 for generating a new unlock password, noted PW0′, for this user for this workstation.

This optional step 130 can be carried out at the workstation. In this case, the new unlock password is stored in said workstation in association with the user, and transmitted to the IdP server for storage. The IdP server can transmit the new unlock password PW0′ to the local network authentication server, or to the local network identity repository, for storage.

This optional step 130 can be carried out at the IdP server. In this case, the new unlock password PW0′ is stored on the IdP server and transmitted to the workstation on the one hand, and to the local network authentication server or local network identity repository on the other hand, for storage.

The new password can be generated using any known technique.

After the authentication phase 110, the method 100 may further comprise an optional step 132 in which the IdP server provides the workstation with a unified proof of authentication for this user, for example in the form of an authentication token, such as an SSO token, or an authentication certificate.

This proof of authentication can be used during the user's session to access other resources, such as SaaS applications accessible through a web browser, or the like.

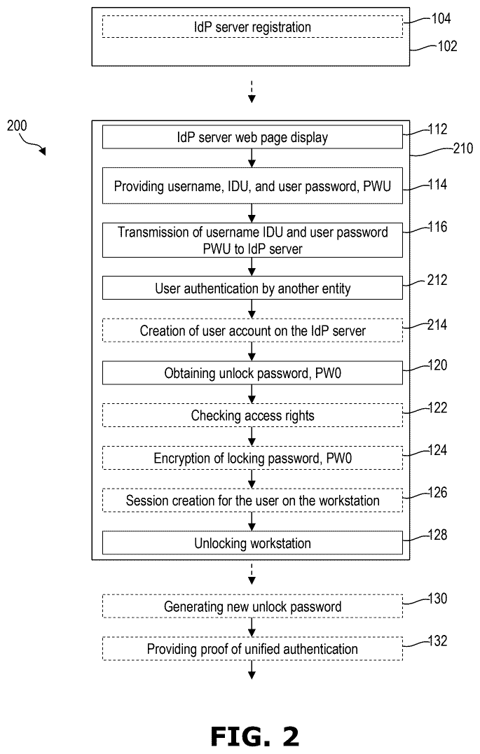

FIG. 2 is schematically shows another example of an authentication method according to one or more embodiments of the invention.

In the method 200, shown in FIG. 2, unlike the method 100, it is assumed that the user who wishes to unlock the workstation is not known to the IdP server. In other words, the IdP server is used by a new user.

The method 200 can comprise the optional step 104 of the method 100, but by the optional step 106.

The method 200 comprises an authentication phase 210 comprising steps 112 to 116, as described with reference to the method 100.

However, in the method 200, user authentication cannot be carried out by the IdP server, since it does not know the user. Thus, after step 116, the authentication phase 210 of the method 200 comprises a step 212 of authenticating the user by an entity other than the IdP server. This other entity may be a LAN authentication server, a LAN identity repository, or an IDAAS server used by the LAN, and with which the IdP server has been previously provisioned, for example in optional step 104.

In step 212, the IdP server transmits the username IDU and user password PWU received in step 116 to said other entity for authentication. It should be noted that, in the method 200, the username IDU and user password PWU, received in step 116, are not associated with a user account of said user with the IdP server, since the latter does not know said user. The username IDU and user password PWU, received in step 116, are associated with said user at said other entity that has been requested to authenticate the user.

If authentication fails, the method 200 is terminated at step 212. Optionally, authentication failure data is transmitted to the workstation, and/or an error message is displayed by the workstation, or by the authentication client launched in step 112, for the user's attention.

If authentication is successful in step 212, the authentication phase may comprise an optional step 214 to create a user account on the IdP server for this user, with the same username IDU/password PWU pair provided by the user, or another username/password pair. In the latter case, the username/password pair can be communicated to the user by any known and appropriate means.

The method 200 then continues with step 120 and subsequent steps described with reference to the method 100 in FIG. 1, by way of at least one embodiment.

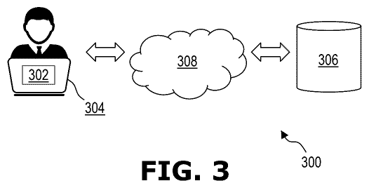

FIG. 3 is a schematic depiction of a non-limiting example of an authentication system according to one or more embodiments of the invention.

The system 300 can be used to implement the method according to at least one embodiment of the invention, and in particular any one of methods 100 or 200.

The system 300 comprises an authentication client 302 installed on a workstation 304.

The system 300 comprises an identity server, IdP server, 306 in communication with the authentication client 302, via a wired or wireless link, through a communication network 308, for example of the Internet type.

The authentication client 302 and IdP server are configured, in hardware and/or software, to implement a method according to at least one embodiment of the invention, and in particular the method 100 or the method 200.

In particular, the authentication client 302 can be configured to carry out some or all of steps 106, 112-116, 126 and 128 of methods 100 or 200.

In particular, the IdP server 306 can be configured to carry out some or all of steps 104, 118-124, 130 and 132 of the method 100, or steps 104, 212-214, 120-124, 130-132 of the method 200.

The IdP server 306 can comprise the following modules (not shown):
a communication module,
optionally, a user authentication module;
optionally, an encryption module;
optionally, a password generation module.

The authentication client 302 installed on the workstation 304 may comprise the following modules (not shown):
a communication module,
optionally, an encryption module;
optionally, a password generation module. [symbol] Generally speaking, the at least one embodiment of the invention is ted to the examples described, which are given by way of illustration. us variants can be envisaged for the examples given above without ig from the scope of the invention as defined in the main claims.

1. A method for authenticating a user on a workstation belonging to a local network, with a view to unlocking said workstation and opening a session on an operating system of said workstation, said method comprising:
an authentication phase comprising
displaying, by said workstation, a web page from an identity server, called IdP server;
providing, by said user to said IdP server, and through said web page, a username for said user and a user password;
authenticating said user based on said username and said user password;
in case of successful authentication, transmitting, by said IdP server to said workstation, an unlock password for unlocking said workstation; and
unlocking said workstation with said unlock password.

2. The method according to claim 1, wherein the user password supplied by the user is the unlock password.

3. The method according to claim 1, wherein the user password supplied by the user is different from the unlock password.

4. The method according to claim 3, wherein the unlock password is known and stored by the IdP server.

5. The method according to claim 3, wherein the authentication phase further comprises obtaining, by the IdP server, the unlock password from a third-party entity.

6. The method according to claim 1, further comprising encrypting the unlock password before transmitting it to the workstation.

7. The method according to claim 1, further comprising updating, or changing, the unlock password.

8. The method according to claim 1, wherein, when the user is known to the IdP server, the authenticating is carried out by said IdP server.

9. The method according to claim 1, wherein, when the user is not known to the IdP server, the authenticating is carried out by a third-party authentication entity comprising a local network authentication server.

10. The method according to claim 1, wherein the authentication phase further comprises creating a user account on the workstation, following the authenticating and before the unlocking of the workstation.

11. The method according to claim 1, further comprising transmitting, by the IdP server to the workstation, a proof of authentication specific to the IdP server, which is used to access at least one SaaS application.

12. The method according to claim 11, further comprising, before the transmitting the unlock password to the workstation, verifying an access condition associated with said user or said workstation, including a condition relating to an access location or an access time.

13. A non-transitory computer medium comprising a program with computer instructions, which when executed by a computer, cause the computer to implement a method for authenticating a user on a workstation belonging to a local network with a view to unlocking said workstation and opening a session on an operating system of said workstation, said method comprising:
an authentication phase comprising
displaying, by said workstation, a web page from an identity server, called IdP server;
providing, by said user to said IdP server, and through said web page, a username for said user and a user password;
authenticating said user based on said username and said user password;
in case of successful authentication, transmitting, by said IdP server to said workstation. an unlock password for unlocking said workstation: and
unlocking said workstation with said unlock password.

14. A system that authenticates a user on a workstation, in order to unlock said workstation and open a session on an operating system of said workstation, said system comprising:
an authentication client installed on said workstation, which is run before unlocking said workstation; and
an identity server, comprising an IdP server;
wherein the system is configured to implement a method for authenticating said user on the workstation belonging to a local network with a view to unlocking said workstation and opening said session on said operating system of said workstation, said method comprising:
an authentication phase comprising
displaying, by said workstation, a web page from said IdP server:
providing, by said user to said IdP server, and through said web page, a username for said user and a user password;
authenticating said user based on said username and said user password:
in case of successful authentication, transmitting. by said IdP server to said workstation, an unlock password for unlocking said workstation; and
unlocking said workstation with said unlock password.
